(19) United States
(12) Patent Application Publication
(10) Pub. No.: US 2026/0147544 A1
(43) Pub. Date: May 28, 2026

(54) STABLE ASYNCHRONOUS OBJECT

(71) Applicant: Toyota Jidosha Kabushiki Kaisha, Toyota-shi (JP)

(72) Inventor: Kirk Shoop, Seattle, WA (US)

(73) Assignee: Toyota Jidosha Kabushiki Kaisha, Toyota-shi (JP)

(21) Appl. No.: 18/956,686

(22) Filed: Nov. 22, 2024

(51) Int. Cl. G06F 8/30

(52) U.S. Cl. CPC G06F 8/315

(57) ABSTRACT

A method of asynchronous programming may include constructing an asynchronous object in a movable state, moving the asynchronous object to a final location, calling a stabilize function on the asynchronous object that constructs a stabilized asynchronous object from the asynchronous object that prevents the asynchronous object from being copied or moved, receiving notification that operations are complete, and destructing the stabilized asynchronous object.

### TECHNICAL FIELD

The present specification relates to asynchronous programming, and more particularly, to a stable asynchronous object.

### BACKGROUND

Asynchronous programming is a computer programming technique that allows multiple processes to run independently and concurrently without blocking each other. This technique may can help reduce wait times and lags in computer programs. However, certain programming languages do not provide native support for asynchronous programming. Accordingly, there is a need for a method of allowing for asynchronous programming in such languages.

### SUMMARY

In one embodiment, a method may include constructing an asynchronous object in a movable state, moving the asynchronous object to a final location, calling a stabilize function on the asynchronous object that constructs a stabilized asynchronous object from the asynchronous object that prevents the asynchronous object from being copied or moved, receiving notification that operations are complete, and destructing the stabilized asynchronous object.

In another embodiment, a computing device may include one or more processors configured to construct an asynchronous object in a movable state, move the asynchronous object to a final location, call a stabilize function on the asynchronous object that constructs a stabilized asynchronous object from the asynchronous object that prevents the asynchronous object from being copied or moved, receive notification that operations are complete, and destruct the stabilized asynchronous object.

In another embodiment, a non-transitory storage medium may include a memory storing instructions that, when executed by one or more processors, cause the one or more processors to construct an asynchronous object in a movable state, move the asynchronous object to a final location, call a stabilize function on the asynchronous object that constructs a stabilized asynchronous object from the asynchronous object that prevents the asynchronous object from being copied or moved, receive notification that operations are complete, and destruct the stabilized asynchronous object.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts an illustrative computing network for a system for implementing the stable asynchronous object, according to one or more embodiments shown and described herein;

FIG. 2 schematically depicts the server computing device of FIG. 1, according to one or more embodiments shown and described herein; and

FIG. 3 depicts a flowchart of a method of operating the server computing device of FIGS. 1 and 2, according to one or more embodiments shown and described herein.

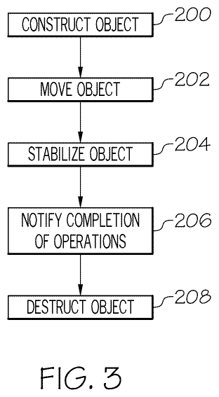

### DETAILED DESCRIPTION

In computer languages that use garbage collection, in order to perform asynchronous programming, garbage collection may be used to hold objects needed during an operation. In idiomatic C++ without concurrency, nested blocks define a static structure that contains the object.

Most C++ concurrent libraries and code use std::shared ptr for ad-hod garbage collection. However, this not only adds heap allocations and ref-count management, it also removes the structure of nested blocks that idiomatic C++ uses to ensure that object construction and destruction happen in a deterministic order.

In one example, this may be solved for concurrent C++ code by having a C++ function return an object that holds all the state for an operation. In C++ 17, guaranteed return value optimization was added, which enabled a non-movable and non-copyable object returned from a function to run the constructor once in its final location. This provides the state with a stable location to ensure deterministic construction and destruction.

There are constraints that prevent code in certain domains (safety-critical regulated, certification) from using C++ 17. A solution for providing a stable location for a C++ object returned from a function in C++ 14 is disclosed herein that uses a two-phase construction for an object.

In one example, a stabilize_t function object is added that uses a custom implementation of T::stabilize (T&, stabilize_t) that will make T stable and disable move-construction and move-assignment. A global constexpr instance stabilize_t stabilize may also be used to select the custom implementation.

The embodiments disclosed herein enable high-performance asynchronous programming in an object-oriented programming language, like C++, without the overhead of state allocation and reference counting. Certain programming languages, such as C++ 14, do not provide native support for asynchronous programming. Conventionally, asynchronous programming is implemented in this version of C++ by allocating asynchronous state on a heap and utilizing memory management techniques like reference counting to track when state is no longer needed and can be freed. However, such memory allocation and reference counting add a performance overhead that is unnecessary for synchronous programming. Accordingly, in embodiments disclosed herein, asynchronous object stabilization is presented, which allows objects to have stable pointers regardless of where they are constructed. This may eliminate the overhead memory allocation and management for asynchronous state.

In embodiments, two-phase object stabilization is disclosed to support efficient asynchronous programming. The first phase is an initial construction phase. An asynchronous object can be constructed in a movable state to enable movement to a final location. The second phase is a stabilization phase. A stabilized function can be called that prevents the object from being copied or moved. The pointer to the object and its content are then stable and will not change. A function caller can provide space for construction of the stabilized object. Once operations are complete, the caller can be notified, and in response, the caller can destruct the object, or instance, by deallocating the object and setting its pointer to a null state.

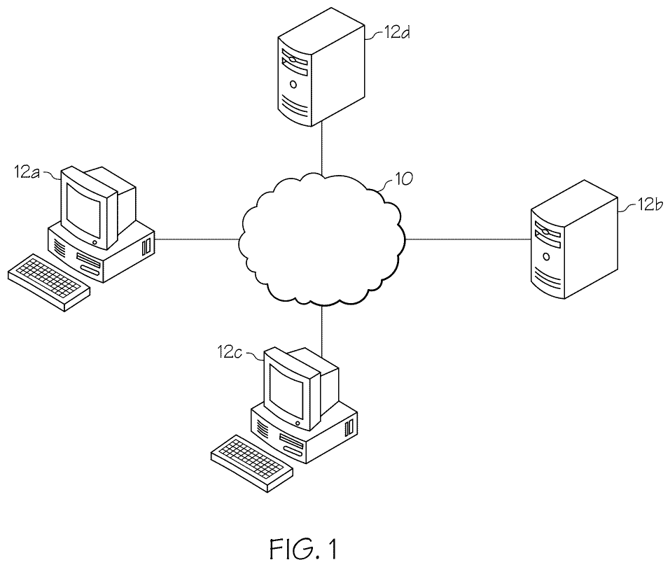

Referring now to the drawings, FIG. 1 depicts an illustrative computing network that depicts components for a system for implementing the stable asynchronous object, according to embodiments shown and described herein. As illustrated in FIG. 1, a computer network 10 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 10 may generally be configured to electronically connect one or more computing devices and/or components thereof. Illustrative computing devices may include, but are not limited to, a user computing device 12a, a server computing device 12b, an administrator computing device 12c, and an external data source computing device 12d.

The user computing device 12a may generally be used as an interface between a user and the other components connected to the computer network 10. Thus, the user computing device 12a may be used to perform one or more user-facing functions, such as receiving one or more inputs from a user or providing information to the user, as described in greater detail herein. Accordingly, the user computing device 12a may include at least a display and/or user input hardware. In some embodiments, the user computing device 12a may contain the software and/or the software addition that provides the functionality for the stable asynchronous object, as described herein. Additionally, included in FIG. 1 is the administrator computing device 12c. In the event that the server computing device 12b requires oversight, updating, or correction, the administrator computing device 12c may be configured to provide the desired oversight, updating, and/or correction. The administrator computing device 12c may also be used to input additional data into a corpus of data stored on the server computing device 12b.

The server computing device 12b may receive data from one or more sources, generate data, store data, index data, search data, and/or provide data to the user computing device 12a in the form of a software program, document fills, an embedded webpage, and/or the like.

The external data source computing device 12d may generally be a repository for saving search strings, corresponding search results, user-stored data, data from third party providers, and/or the like.

It should be understood that while the user computing device 12a and the administrator computing device 12c are depicted as personal computers and the server computing device 12b and the external data source computing device 12d are depicted as servers, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the user computing device 12a, the server computing device 12b, the administrator computing device 12c, and the external data source computing device 12d may represent a plurality of computers, servers, databases, components, and/or the like.

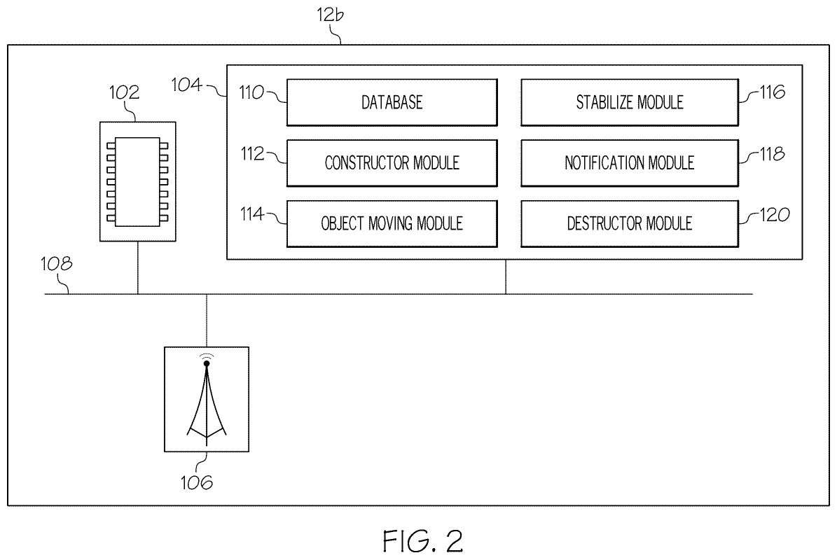

FIG. 2 depicts the server computing device 12b from FIG. 1, for implementing the asynchronous object as disclosed herein. While the components depicted in FIG. 2 are described with respect to the server computing device 12b, it should be understood that similar components may also be used for the user computing device 12a, the administrator computing device 12c, and/or the external data source computing device 12d without departing from the scope of the present disclosure.

The server computing device 12b comprises one or more processors 102, one or more memory modules 104, network interface hardware 106, and a communication path 108. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware, and/or any wired or wireless hardware for communicating with other networks and/or devices. In one embodiment, the network interface hardware 106 includes hardware configured to operate in accordance with the Bluetooth® wireless communication protocol. In some examples, the network interface hardware 106 may include two different channels including a Dedicated Short-Range Communication (DSRC) channel and a millimeter wave radio channel, as discussed in further detail below.

The one or more memory modules 104 include a database 110, a constructor module 112, an object moving module 114, a stabilize module 116, a notification module 118, and a destructor module 120. Each of the database 110, the constructor module 112, the object moving module 114, the stabilize module 116, the notification module 118, and the destructor module 120 may be a program module in the form of operating systems, application program modules, and other program modules stored in the one or more memory modules 104. In some embodiments, the program module may be stored in a remote storage device that may communicate with the server computing device 12b. Such a program module may include, but is not limited to, routines, subroutines, programs, objects, components, data structures and the like for performing specific tasks or executing specific data types as will be described below.

The database 110 may store computer code that may be used to implement the asynchronous object disclosed herein. For example, the database 110 may store a computer programming language (e.g., C++). In the illustrated example, the database 110 stores C++ 14. However, in other examples, the database 110 may store other computing languages.

The constructor module 112 may construct an object in a programming language (e.g., C++ 14). The constructor module 112 may create an object that can be moved to a final location. For example, the constructor module 112 can utilize a function to create an object “o” of type “O.,” where the object “o” is movable.

The object moving module 114 may move an object created by the constructor module 112 to a final location. The final location may be a memory location defined by a pointer to that memory location. In particular, a function caller can provide space in memory for construction of an object created by the constructor module 112, and the object moving module 114 may move the object to the provided space in memory.

The stabilize module 116 may prevent the object created by the constructor module 112 from being copied or moved. For example the stabilize module 116 may utilize a function that can be called on the object “o,” (e.g., “stabilize (o)”), which prevents object “o” from being copied or moved.

The notification module 118 may notify a caller function when a process associated with the created object is complete. For example, after an object is created with the constructor module 112 and moved with the object moving module 114, a start method can be called on the object “o” (e.g., “o.start( )”) that initiates a process associated with the object. The notification module 118 can cause the process to notify the caller function when the process is complete (e.g., “O:::complete( )”).

The destructor module 120 may deallocate an object created by the constructor module 112. For example, after completion of the called process on the object, the destructor module 120 may cause the caller function to deallocate the object “o” and set its pointer to null. Example pseudocode for implementing the asynchronous object is shown below.

```
struct stabilize_t {
  template<class T>
  void operator( )(T& t) const { std::decay_t<T>::stabilize(t, *this); }
};
static constexpr stabilize_t stabilize{ };
struct A { };
struct B { };
struct Data {
  ~Data( ) { puts(“~Data”); }
  explicit Data(A a, B b) : a(a), b(b) { puts(“Data”); }
  B b;
};
class O;
extern void operation(Data*, O* o, void(*c)(O*)) {
  // use Data* during operation
  // after operation invoke complete
  c(o);
}
class O {
  A a;
  B b;
public:
  ~O( ) {
  puts(“~O”);
}
explicit O(A a, B b) : a(a), b(b) { puts(“O”); }
O(const O&) = delete;
O& operator=(const O&) = delete;
O(O&& o) : a(std::move(o.a)), b(std::move(o.b)) { puts(“O&&”); if (o.d.has_value( ))
{std::terminate( );} }
O& operator=(O&& o) {
  puts(“= O&&”);
  // must not be stabilized
  if (o.d.has_value( )) {std::terminate( );}
  a = std::move(o.a);
  b = std::move(o.b);
  return *this;
}
private:
  std::optional<Data> d;
static void complete(O* o) {
// use Data* during operation
  // now it is safe to destruct data
  o->d.reset( );
  puts(“completed”);
}
public:
static void stabilize(O& o, stabilize_t) {
  o.d.emplace(std::move(o.a), std::move(o.b));
}
void start( ) {
  // must be stabilized
  if (!d.has_value( )) {std::terminate( );}
  // this, a*, and b* will be valid after
  // operation( ) and start( ) return
  puts(“started”);
  operation(&*d, this, &O::complete);
  }
};
O makeO( ) { O o{A{ }, B{ }}; return std::move(o); }
int main( ) {
  O o = makeO( );
  stabilize(o);
  o.start( );
  // Must wait for O::complete( ) before allowing
  // the stabilized ‘o’ to destruct.
}
```

Another example pseudocode for implementing the asynchronous object is shown below.

```
class O {
// . . .
  tbd::optional<Data> d;
  static void complete(O* o) {
    // use Data* during operation
    // now it is safe to destruct data
    o->d.reset( );
  }
public:
  static void stabilize(O& o, stabilize_t) {
    o.d.emplace(std::move(o.a), std::move(o.b));
  }
  void start( ) {
    // must be stabilized
    if (!d.has_value( )) {std::terminate( );}
    // this, a*, and b* will be valid after
    // operation( ) and start( ) return
    operation(&*d, this, &O::complete);
  }
};
O makeO( ) { O o{A{ }, B{ }}; return std::move(o); }
int main( ) {
  O o = makeO( );
  stabilize(o);
  o.start( );
  // Must wait for O::complete( ) before allowing
  // the stabilized ‘o’ to destruct.
}
```

FIG. 2 depicts a flowchart of an example method for operating the server computing device 12b to implement the asynchronous object disclosed herein.

At step 200, the constructor module 112 constructs an asynchronous object in a movable state. In embodiments, the constructor module 112 may construct an object in a programming language (e.g., C++ 14). The constructor module 112 may create an object that can be moved to a final location. For example, the constructor module 112 can utilize a function to create an object “o” of type “O.,” where the object “o” is movable.

At step 202, the object moving module 114 moves the object created by the constructor module 112 to a final location. In embodiments, the object moving module 114 may move an object created by the constructor module 112 to a final location. The final location may be a memory location defined by a pointer to that memory location. In particular, a function caller can provide space in memory for construction of an object created by the constructor module 112, and the object moving module 114 may move the object to the provided space in memory.

At step 204, the stabilize module 116 calls a stabilize function on the created object that constructs a stabilized asynchronous object from the asynchronous object that prevents the asynchronous object from being copied or moved. In embodiments, the stabilize module 116 may prevent the object created by the constructor module 112 from being copied or moved. For example, the stabilize module 116 may utilize a function that can be called on the object “o,” (e.g., “stabilize (o)”), which prevents object “o” from being copied or moved.

At step 206, the notification module 118 notifies a calling function that operations to be performed on the created object are complete. In embodiments, the notification module 118 may notify a caller function when a process associated with the created object is complete. For example, after an object is created with the constructor module 112 and moved with the object moving module 114, a start method can be called on the object “o” (e.g., “o.start( )”) that initiates a process associated with the object. The notification module 118 can cause the process to notify the caller function when the process is complete (e.g., “O:::complete ( )”).

At step 208, the destructor module 120 destructs the stabilized asynchronous object. In embodiments, the destructor module 120 may deallocate an object created by the constructor module 112. For example, after completion of the called process on the object, the destructor module 120 may cause the caller function to deallocate the object “o” and set its pointer to null.

It should now be understood that embodiments described herein are directed to creating asynchronous objects in a computer programming language that have stable unchanging pointers regardless of where they are constructed. The object stabilization enables efficient asynchronous programming without the overhead of conventional approaches such as state allocation and reference counting in a programming language that does not natively support stable returned objects.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of asynchronous programming, comprising:
constructing an asynchronous object in a movable state;
moving the asynchronous object to a final location;
calling a stabilize function on the asynchronous object that constructs a stabilized asynchronous object from the asynchronous object that prevents the asynchronous object from being copied or moved;
receiving notification that operations are complete; and
destructing the stabilized asynchronous object.

2. The method of claim 1, further comprising constructing the asynchronous object using C++.

3. The method of claim 1, further comprising constructing the asynchronous object using C++ 14.

4. The method of claim 1, wherein a pointer associated with the stabilized asynchronous object cannot be changed.

5. The method of claim 1, further comprising calling a function to perform the operations on the stabilized asynchronous object.

6. The method of claim 1, wherein destructing the stabilized asynchronous object comprises deallocating the stabilized asynchronous object.

7. The method of claim 1, wherein destructing the stabilized asynchronous object comprises setting a pointer associated with the stabilized asynchronous object to null.

8. A computing device comprising one or more processors, configured to:
construct an asynchronous object in a movable state;
move the asynchronous object to a final location;
call a stabilize function on the asynchronous object that constructs a stabilized asynchronous object from the asynchronous object that prevents the asynchronous object from being copied or moved;
receive notification that operations are complete; and
destruct the stabilized asynchronous object.

9. The computing device of claim 8, wherein the one or more processors are further configured to construct the asynchronous object using C++.

10. The computing device of claim 8, wherein the one or more processors are further configured to construct the asynchronous object using C++ 14.

11. The computing device of claim 8, wherein a pointer associated with the stabilized asynchronous object cannot be changed.

12. The computing device of claim 8, wherein the one or more processors are further configured to perform the operations on the stabilized asynchronous object.

13. The computing device of claim 8, wherein the one or more processors are further configured to destruct the stabilized asynchronous object by deallocating the stabilized asynchronous object.

14. The computing device of claim 8, wherein the one or more processors are further configured to destruct the stabilized asynchronous object by setting a pointer associated with the stabilized asynchronous object to null.

15. A non-transitory storage medium comprising a memory storing instructions that, when executed by one or more processors, cause the one or more processors to:
construct an asynchronous object in a movable state;
move the asynchronous object to a final location;
call a stabilize function on the asynchronous object that constructs a stabilized asynchronous object from the asynchronous object that prevents the asynchronous object from being copied or moved;
receive notification that operations are complete; and
destruct the stabilized asynchronous object.

16. The non-transitory storage medium of claim 15, wherein the instructions further cause the one or more processors to construct the asynchronous object using C++.

17. The non-transitory storage medium of claim 15, wherein the instructions further cause the one or more processors to construct the asynchronous object using C++ 14.

18. The non-transitory storage medium of claim 15, wherein a pointer associated with the stabilized asynchronous object cannot be changed.

19. The non-transitory storage medium of claim 15, wherein the instructions further cause the one or more processors to destruct the stabilized asynchronous object by deallocating the stabilized asynchronous object.

20. The non-transitory storage medium of claim 15, wherein the instructions further cause the one or more processors to destruct the stabilized asynchronous object by setting a pointer associated with the stabilized asynchronous object to null.
